(19) United States
(12) Patent Application Publication
(10) Pub. No.: US 2013/0044754 A1
(43) Pub. Date: Feb. 21, 2013

(54) METHOD, APPARATUS AND SYSTEM FOR ACQUIRING MEDIA ACCESS CONTROL ADDRESS

(71) Applicant: HUAWEI TECHNOLOGIES CO., LTD., Shenzhen (CN)

(72) Inventor: Guojun Zhu, Shenzhen (CN)

(73) Assignee: HUAWEI TECHNOLOGIES CO., LTD., Shenzhen (CN)

(21) Appl. No.: 13/659,034

(22) Filed: Oct. 24, 2012

Related U.S. Application Data
(63) Continuation of application No. PCT/CN2011/075331, filed on Jun. 3, 2011.

(30) Foreign Application Priority Data
Dec. 21, 2010 (CN) 2010603483.6

(51) Int. Cl. H04L 12/56

(52) U.S. Cl. 370/392

(57) ABSTRACT

In an Ethernet network, in order to reduce network resource occupancy in obtaining Medium/Media Access Control (MAC) address of a second terminal for a first terminal to enable the first terminal to send data to the second terminal, an embodiment of the present invention provide a method for acquiring a MAC address comprises the following steps: receiving a first address resolution protocol (ARP) broadcast packet from a first terminal; acquiring a MAC address of an ARP server; replacing the destination MAC address of the first ARP broadcast packet with the MAC address of the ARP server; and thereafter sending the first ARP broadcast packet to the ARP server to enable the ARP server to acquire the MAC address of the second terminal according to the first ARP broadcast packet and send an ARP reply packet including the MAC address of the second terminal to the first terminal.

This application is a continuation application of International patent application No. PCT/CN2011/080115, filed Jun. 3, 2011, which claims priority to Chinese Patent Application No. 201010603483.6, filed on Dec. 21, 2010, both of which are incorporated herein by reference in its entirety.

### FIELD OF THE INVENTION

The present invention relates to the field of communications technologies, and in particular, to a method, an apparatus, and a system for acquiring a media access control address.

### BACKGROUND OF THE INVENTION

It is regulated in an Ethernet protocol that, if a host needs to perform direct communication with another host in the same local area network, a MAC (Medium/Media Access Control) address of a target host must be learned. In a TCP/IP protocol (Transmission Control Protocol/Internet Protocol, transmission control protocol/Internet protocol), the network layer and the transmission layer only concern an IP address of the target host. As a result, when an IP protocol is used in the Ethernet, data provided by an upper-layer IP protocol connected to an Ethernet protocol of a data link layer only includes an IP address of a destination host. Therefore, a method is needed to acquire a MAC address of the destination host according to the IP address of the destination host.

In the prior art, a host that initiates communication seeks the destination host by sending an ARP (Address Resolution Protocol) broadcast, and acquires the MAC address of the destination host, and then adds the MAC address in a frame packet as a destination address of the communication. For example, a host A whose IP address is 192.168.1.5 sends data to a host B whose IP address is 192.168.1.1. When sending the data, the host A checks whether a target IP address exists in its own ARP cache table. If yes, a target MAC address is learned, and the target MAC address may be directly written into a frame to be sent; otherwise, if the target IP address is not found in the ARP cache table, the host A sends a broadcast in a network indicating an host A MAC address is “the MAC address of the host A”, which indicates sending a query to all hosts in the same network segment indicating “I am 192.168.1.5, my hardware address is “the MAC address of the host A”, and what is the MAC address whose IP address is 192.168.1.1, please?” Other hosts in the network do not reply to the ARP query. Only when receiving the frame, the host B replies to the host A: “the MAC address of 192.168.1.1 is 00-aa-00-62-c6-09.” In this way, the host A learns the MAC address of the host B, and the host A may send information to the host B. At the same time, the host A and host B update their own ARP cache tables. Because the host A tells the host B its own IP and MAC address together during the query, when the host A re-sends the information to the host B or the host B sends information to the host A next time, the host A or host B may directly perform seeking in their ARP cache table respectively.

During the process of implementing the present invention, the inventor finds that the prior art has the following problems:

By using the ARP, a MAC address corresponding to a certain IP address by broadcasting is acquired. However, because of the adopted broadcast mechanism thereof, when the number of hosts in a second-layer network is large, and when the communication between the hosts is frequent, a large number of ARP broadcast packets emerge in the network. The network bandwidth is severely occupied. Besides, when the MAC address is acquired by using the method, all the hosts need to receive and process the ARP packet, but in reality, only one host needs to reply, and CPU resources of other hosts are consumed. Actual measurement data indicates that, when the number of the ARP packet in the network reaches 1000 per second, a CPU occupancy rate of the host is 30%, thereby causing serious waste of a communication system resource, and affecting the performing of normal communication.

### SUMMARY OF THE INVENTION

In an Ethernet network, in order to reduce network resource occupancy in obtaining Medium/Media Access Control (MAC) address of a second terminal for a first terminal to enable the first terminal to send data to the second terminal, an embodiment of the present invention provide a method for acquiring a MAC address comprises the following steps: receiving a first address resolution protocol (ARP) broadcast packet from a first terminal, wherein the first ARP broadcast packet is used for acquiring a MAC of a second terminal; acquiring a MAC address of an ARP server; replacing the destination MAC address of the first ARP broadcast packet with the MAC address of the ARP server; and after replacing the destination MAC address of the first ARP broadcast packet with the MAC address of the ARP server, sending the first ARP broadcast packet to the ARP server to enable the ARP server to acquire the MAC address of the second terminal according to the first ARP broadcast packet and send an ARP reply packet including the MAC address of the second terminal to the first terminal.

An embodiment of the present invention further provides a hardware proxy device for acquiring MAC address, comprises the following modules. An address resolution protocol (ARP) broadcast packet receiving module is configured to receive a first ARP broadcast packet from a first terminal, wherein the first ARP broadcast packet is used for acquiring a MAC address of a second terminal; a destination address modification module is configured to acquire a MAC address of an ARP server, and replace the destination MAC address of the first ARP broadcast packet with the MAC address of the ARP server; and a modified packet sending module is configured to send the first ARP broadcast packet to the ARP server after the destination MAC address of the first ARP broadcast packet being replaced with the MAC address of the ARP server to enable the ARP server to acquire the MAC address of the second terminal according to the first AEP broadcast packet; and sends an ARP reply packet including the MAC address of the second terminal to the first terminal

An embodiment of the present invention further provides a method for acquiring a MAC address, comprises the following steps: receiving, by a proxy device, a first address resolution protocol (ARP) broadcast packet including a sender MAC address, a sender IP address, a IP address of the second terminal, and a destination MAC address from a first terminal, wherein the first ARP broadcast packet is used for acquiring a MAC of a second terminal; acquiring, by the proxy device, a MAC address of an ARP server; replacing, by the proxy device, the destination MAC address of the first ARP broadcast packet with the MAC address of the ARP server; after replacing the destination MAC address of the first ARP broadcast packet with the MAC address of the ARP server, sending, by the proxy device, the first ARP broadcast packet to the ARP server; receiving, by the ARP server, the first ARP broadcast packet; based upon the first ARP broadcast packet, obtaining, by the ARP server, the IP address of the second terminal; searching, by the ARP server, a mapping table indicating a mapping between MAC addresses and IP addresses for one or more terminals according to the IP address of the second terminal; acquiring the MAC address of the second terminal based up on the searching; and sending, by the ARP server, an ARP reply packet including the MAC address of the second terminal to the first terminal

In an Ethernet network, in order to reduce network resource occupancy in obtaining Medium/Media Access Control (MAC) address of a second terminal for a first terminal to enable the first terminal to send data to the second terminal, an embodiment of the present invention provides a system for acquiring a MAC address, the system comprising: a hardware proxy device, configured to receive, a first address resolution protocol (ARP) broadcast packet including a sender MAC address, a sender IP address, a IP address of the second terminal, and a destination MAC address from a first terminal, wherein the first ARP broadcast packet is used for acquiring a MAC of a second terminal; acquire a MAC address of an ARP server; replace the destination MAC address of the first ARP broadcast packet with the MAC address of the ARP server; and after replacing the destination MAC address of the first ARP broadcast packet with the MAC address of the ARP server, send the first ARP broadcast packet to the ARP server; and the ARP server, configured to receive, by the ARP server, the first ARP broadcast packet; based upon the first ARP broadcast packet, obtain the IP address of the second terminal; search a mapping table indicating a mapping between MAC addresses and IP addresses for one or more terminals according to the IP address of the second terminal; acquire the MAC address of the second terminal based up on the searching; and send an ARP reply packet including the MAC address of the second terminal to the first terminal

In the embodiments of the present invention, the address of the ARP server is acquired, and the destination address of the first ARP broadcast packet is replaced with the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### BRIEF DESCRIPTION OF THE DRAWINGS

FIG. 1 is a flow chart of a method for acquiring a MAC address according to Embodiment 1 of the present invention;

FIG. 2 is an information interaction diagram of a method for acquiring a MAC address according to Embodiment 2 of the present invention;

FIG. 3 is a schematic structural diagram of a network according to Embodiment 2 of the present invention;

FIG. 4 is an information interaction diagram of a method for acquiring a MAC address according to Embodiment 3 of the present invention;

FIG. 5 is an information interaction diagram of updating ARP server address information in a method for acquiring a MAC address according to Embodiment 3 of the present invention;

FIG. 6 is an information interaction diagram of S409 to S410 in a method for acquiring a MAC address according to Embodiment 4 of the present invention;

FIG. 7A and FIG. 7B is an information interaction diagram of a method for acquiring a MAC address according to Embodiment 5 of the present invention;

FIG. 8A and FIG. 8B is an information interaction diagram of a method for acquiring a MAC address according to Embodiment 6 of the present invention;

FIG. 9 is a schematic structural diagram of a proxy module according to Embodiment 7 of the present invention;

FIG. 10 is a schematic structural diagram of another proxy module according to Embodiment 8 of the present invention;

FIG. 11 is a schematic structural diagram of an ARP server according to Embodiment 9 of the present invention;

FIG. 12 is a schematic structural diagram of another ARP server according to Embodiment 10 of the present invention; and

FIG. 13 is a schematic structural diagram of a system for acquiring a media access control address according to Embodiment 11 of the present invention.

### DETAILED DESCRIPTION OF THE EMBODIMENTS

To make the objectives, technical solutions, and advantages of the present invention more comprehensible, the following describes the embodiments of the present invention in further detail with reference to the accompanying drawings.

### Embodiment 1

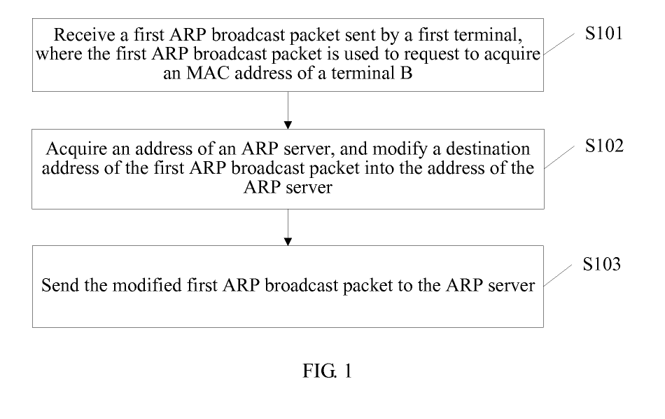

As shown in FIG. 1, an embodiment of the present invention provides a method for acquiring a MAC address, and the method includes the following steps:

S101: Receive a first ARP broadcast packet sent by a first terminal, where the first ARP broadcast packet is used to request to acquire a MAC address of a second terminal

S102: Acquire an address of an ARP server, and replace a destination address of the first ARP broadcast packet with the address of the ARP server.

S103: Send the modified first ARP broadcast packet to the ARP server, and the ARP server acquires the MAC address of the second terminal according to the modified first ARP broadcast packet, and sends an ARP reply packet to the first terminal, where the ARP reply packet includes the MAC address of the second terminal

It should be noted that, in Embodiment 1 of the present invention, a subject of executing steps S101 to S103 may be an apparatus for acquiring the MAC address. The apparatus may be an independent physical device, may be located in software for terminal communication, may be located in a virtual switch in a server, or may be located in a switch. The position of the subject position should be located between a host network interface and a device of a second-layer network access layer. Before the ARP broadcast packet of the host is forwarded to the overall second-layer network, the ARP broadcast packet is intercepted.

In the embodiment of the present invention, the address of the ARP server is acquired, and the destination address of the first ARP broadcast packet is replaced with the address of the ARP server; the ARP broadcast packet becomes a unicast packet sent to only the ARP server. Thus, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### Embodiment 2

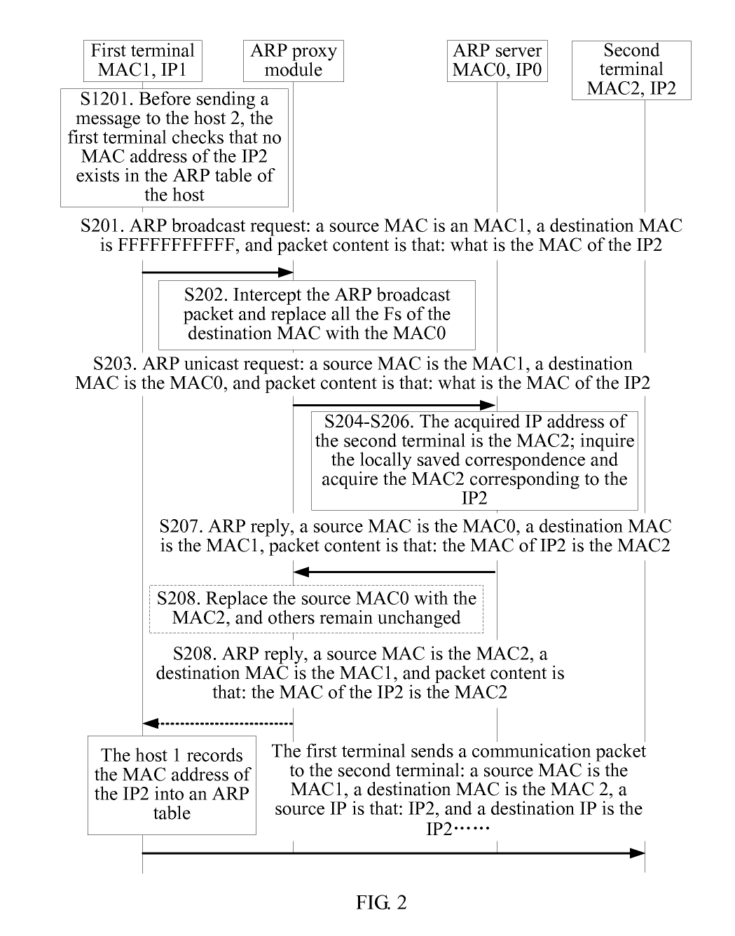

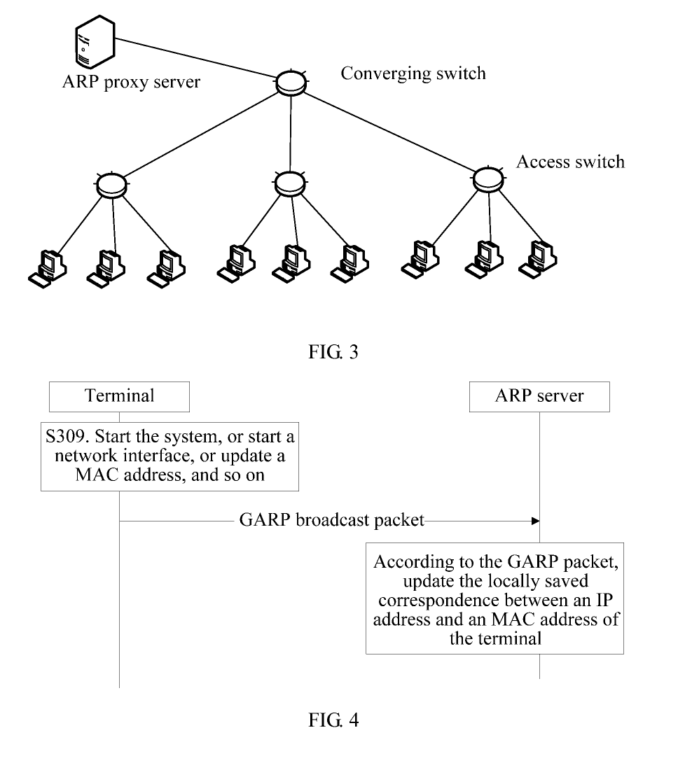

As shown in FIG. 2, an embodiment of the present invention provides a method for acquiring a MAC address, a subject of executing each step in the method of this embodiment may be a device or a software module. The position of the device or the software module is located between a terminal network interface and a device of a second-layer network access layer as shown in a network structural diagram shown in FIG. 3. Before an ARP broadcast packet of the host is forwarded to the overall second-layer network the ARP broadcast packet is intercepted. This embodiment selects an ARP proxy module as an example, and the method includes the following steps:

S201: The ARP proxy module receives a first ARP broadcast packet sent by a first terminal, where the first ARP broadcast packet is used to acquire a MAC address of a second terminal

The first ARP broadcast packet is a standard ARP broadcast packet. The packet includes a MAC address and an IP address of a packet sender, an IP address of a packet receiver, and a broadcast MAC address servers as a destination address which is “FF.FF.FF.FF.FF.FF”, which indicates sending queries to all hosts in the same network segment, and all the hosts in the same network segment receive the broadcast.

For example, before sending a message to the second terminal, the first terminal checks that there is no MAC address corresponding to the IP address of the second terminal exists in the ARP table of the first terminal. An ARP broadcast request includes: a source MAC which is MAC1; a destination MAC which is FFFFFFFFFFF; and packet content is that: “what is the MAC of IP2?” VM is used to indicate each terminal with a communication demand. The first terminal whose IP address is IP1 has learned an IP address of the second terminal, the first terminal needs to communicate with the second terminal, the first terminal does not have ARP information of the second terminal locally; and the first terminal initiates a broadcast requested by the ARP.

S202: The ARP proxy module acquires a locally saved address of an ARP server, and replaces a destination address of the first ARP broadcast packet with an address of the ARP server.

Because the ARP proxy module is located between each terminal network interface and the device of the second-layer network access layer, the ARP proxy module may intercept information sent by each terminal to devices in the second-layer network.

Optionally, the locally saved address information of the ARP server may be the IP address of the ARP server, or may be directly the MAC address of the ARP server, or an IP address and a MAC address of the APR proxy server; if there is only the IP address of the ARP server, the ARP proxy module needs to initiate a standard ARP request process, and acquire the MAC address of the ARP server.

Specifically, when the locally saved address of the APR server is the MAC address of the ARP server, the destination MAC address of the first ARP broadcast packet is replaced with the MAC address of the ARP server.

When the locally saved address of the APR server is the IP address of the ARP server, a second ARP broadcast packet corresponding to the MAC address of the ARP server acquired according to the IP address of the ARP server, and the destination MAC address of the first ARP broadcast packet is replaced with the acquired MAC address of the ARP server.

For example, when the ARP proxy module intercepts the ARP broadcast packet sent by the first terminal in S201, all the Fs of the destination MAC are replaced with an MAC0. That is, when the ARP proxy module intercepts the ARP broadcast packet sent by the first terminal in S201, first check whether there is the MAC address of the ARP server saved locally, namely MAC0; if there already exists the MAC0, the destination address in the packet is replaced with the MAC0, if no MAC information exists, but only IP information, the ARP request process is initiated first, the MAC address of the ARP server is acquired, and the foregoing replacement operation is then performed. After the replacement is completed, the packet whose destination MAC address is replaced is sent to the network. If no MAC address of the ARP server is acquired, the broadcast packet may be discarded or directly sent out.

S203: The ARP proxy module sends the modified first ARP broadcast packet to the ARP server according to the address of the ARP server.

Specifically, the broadcast packet whose destination MAC address is replaced becomes a unicast packet that is sent to only the ARP server, the source MAC of the ARP unicast request is the MAC1, the destination MAC is the MAC0, and the packet content is that: “what is the MAC of IP2?”

S204: After receiving the replaced first ARP broadcast packet, the ARP server acquires the IP address of the second terminal in the modified first ARP broadcast packet.

S205: The ARP server acquires the locally saved correspondence between the IP address of the terminal and the MAC address of the terminal.

S206: According to the IP address of the second terminal, the ARP server inquires the correspondence between the IP address of the terminal and the MAC address of the terminal, and acquires the MAC address corresponding to the IP address of the second terminal

Specifically, after receiving an ARP request packet whose destination MAC address is the MAC address of the ARP server, the ARP server resolves the content of the packet, acquires the IP address of the second terminal, and inquires the MAC address corresponding to the IP2 through the locally saved correspondence between the IP address of the terminal and the MAC address of the terminal. If the record is found, the MAC address in the correspondence is used as the MAC address of IP2.

S207: The ARP server sends an ARP reply packet to the first terminal, where the ARP reply packet includes the MAC address of the second terminal.

Specifically, the ARP server sends an ARP reply message (ARP reply) to the first terminal. The source MAC address of the ARP Reply packet is the MAC address MAC0 of the ARP server, and the destination MAC address is the MAC1 of the first terminal. In the packet, the sent MAC Address is the MAC2 of the second terminal, and the sent IP Address is IP2 of the second terminal; and in the packet, the destination MAC Address is the MAC1 of the first terminal, and the destination IP Address is the IP1 of the first terminal. The packet content is that: the MAC of the IP2 is the MAC2.

S208: Acquire the ARP reply packet, replace a source MAC address in the ARP reply packet with the MAC address of the second terminal, and replace a source IP address in the ARP reply packet with the IP address of the second terminal.

By executing the foregoing steps, the first terminal may perform communication with the second terminal, send a communication packet to the second terminal, where the source MAC of the packet is the MAC address of the first terminal, namely the MAC1; and the destination MAC address is the MAC address of the second terminal, namely the MAC2.

It should be noted that, in Embodiment 2 of the present invention, a subject of executing each step may be an apparatus for acquiring the MAC address. The apparatus may be a single physical device, and may be located in software for terminal communication, or located in a virtual switch in a server, or located in a switch. Its position should be between the terminal network interface and the device of the second-layer network access layer, so that before the ARP broadcast packet sent by the terminal is forwarded by a switching device to the overall second-layer network, the ARP broadcast packet is intercepted.

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### Embodiment 3

An embodiment of the present invention provides a method for acquiring a MAC address, including step S301 to S310, where step S301 to S308 are the same as step S201 to S208 in Embodiment 2 of the present invention, which are not repeated again herein. For specific steps and figures, refer to Embodiment 2. As shown in FIG. 4, the difference between this embodiment and Embodiment 2 is that this embodiment further includes S309 to S310:

S309: The ARP server receives a GARP broadcast packet sent by a terminal;

Specifically, the terminal sends the GARP broadcast packet when the terminal is started, or a network interface of the terminal is started, or the terminal changes the MAC address.

The format of the GARP broadcast packet is a standard GARP broadcast packet.

S310: The ARP server acquires an IP address of the terminal in the GARP broadcast packet, determines whether a MAC address corresponding to the IP address exists in the locally saved correspondence between the IP address and the MAC address of the terminal. If the MAC address does not exist in the correspondence, the ARP server stores the correspondence between the IP address and the MAC address in the GARP packet in the locally saved correspondence between the IP address and the MAC address of the terminal; and if the MAC address exists in the correspondence, the ARP server determines whether the MAC address corresponding the IP address is consistent with the the MAC address in the GARP broadcast packet, if yes, no processing is performed; and if not, the MAC address in the GAPR broadcast packet is replaced with an original MAC address.

The locally saved correspondence between the IP address and the MAC address of the terminal may be as shown in Table 1:

TABLE 1

| Sequence No. | IP address | MAC address |
|---|---|---|
| 1 | XXXXXXXX | XXXXXXXX |
| 2 | 10.85.132.31 | 00:0f:e2:2f:e4:6c |
| . . . | . . . | . . . |

Preferably, an aging timer may be further set for the received MAC address and the received IP address of each terminal, where the aging timer is configured to record the effectiveness of the stored MAC address and the stored IP address of the terminal. When no MAC address corresponding to the IP address of the terminal in the GARP broadcast packet received by the ARP server exists in the locally saved correspondence between the IP address and the saved MAC address of the terminal, the address relation in the GARP is stored, and at the same time, the aging timer is started; and when the MAC address corresponding to the IP address exists, whether the MAC address corresponding to the IP address is consistent with the MAC address in the GAPR broadcast packet is determined. If yes, the aging timer is updated, namely the current address of the terminal is consider to be effective; and if not, the original MAC address is replaced with the MAC address in the GAPR broadcast packet, and at the same time, the aging timer is updated.

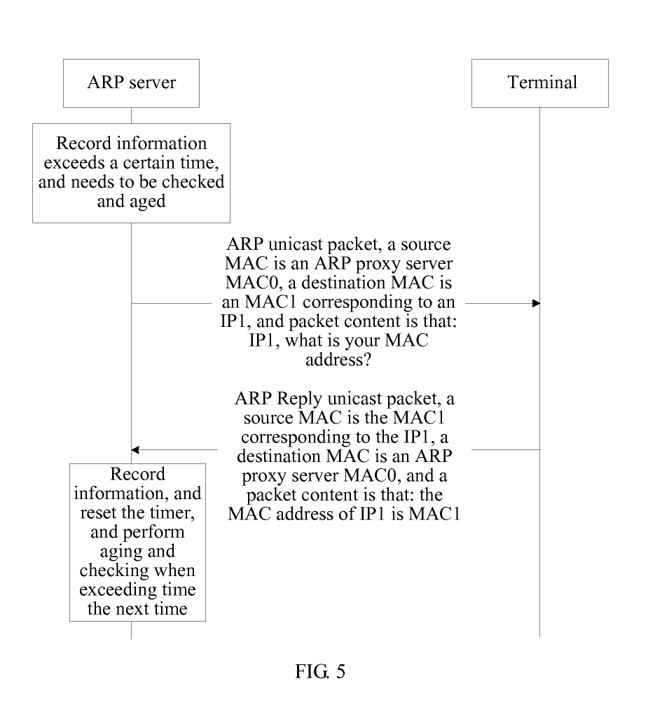

Furthermore, preferably, in order to maintain the accuracy with which the ARP server collects information, the ARP server may send confirmation information to data in a record table at a fixed time in the form of unicast. For example, as shown in FIG. 5, when the address information recorded on the ARP server, namely the correspondence between the MAC address and the IP address, exceeds certain time, and needs to be checked and aged, the ARP server sends the confirmation information to the terminal in the form of an ARP unicast packet, such as a source MAC is an ARP server MAC0; a destination MAC is an MAC1 corresponding to an IP1; and packet content is that: “IP1, what is your MAC address?” The terminal sends an ARP Reply unicast packet corresponding to the ARP packet, such as, the ARP Reply unicast packet is that: the source MAC is the MAC1 corresponding to the IP1; the destination MAC is the MAC0; and the packet content is that: “the MAC address of the IP1 is the MAC1.”

The ARP server receives and records the ARP Reply unicast packet, and re-performs aging and checking on the information when exceeding time the next time.

It should be noted that, the ARP server related to this embodiment is located in a network, and may detect a broadcast message initiated by other terminals. A second-layer broadcast or unicast message sent by the ARP server may also be received by a corresponding host, which may be a server, a network device, or an entity that can receive Ethernet packet information in the network. When each terminal is initially started, a network interface card is started to be used or the MAC address is changed, each terminal in the second-layer Ethernet sends a GARP (Gratuitous ARP, gratuitous ARP) to the network in the form of broadcast, which is used to notify the network device of updating information of a forwarding table, and at the same time, it is convenient for other devices to refresh a local ARP record table.

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved. Besides, in this embodiment, the ARP server actively acquires the correspondence between the IP address and the MAC address of each terminal, and updates the locally stored correspondence according to the GARP packet sent by the terminal, thereby effectively assuring the reliability of the locally stored address information.

### Embodiment 4

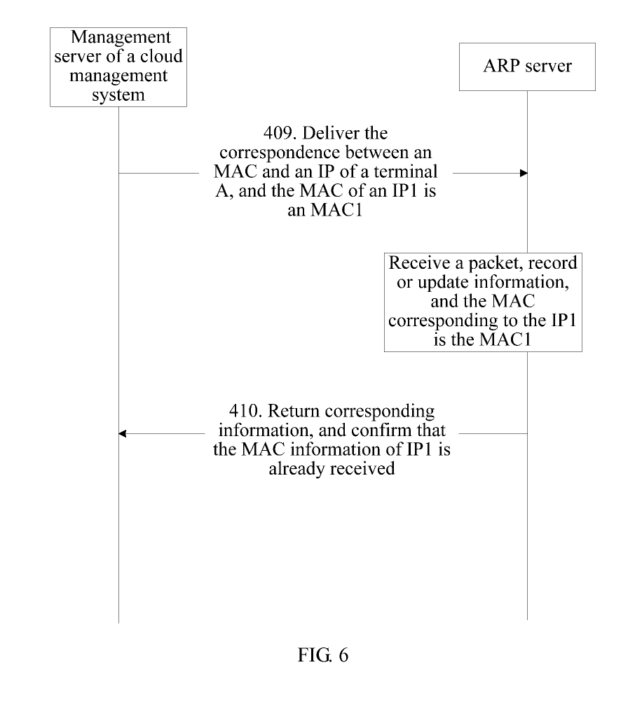

An embodiment of the present invention further provides a method for acquiring a MAC address. The method in this embodiment is mainly applied in a network of a cloud computing virtualized data center, and the method relates to a management server, where the management server is configured to create and manage each terminal of a cloud management system, for example, a virtual machine, allocate an IP and a MAC for each terminal, and set correspondence between the MAC and the IP to the ARP server. The ARP server related in this embodiment is located in a network, and may perform communication with the management server. The method includes steps S401 to S410, where steps S401 to S408 are the same as steps S201 to S208 in Embodiment 2 of the present invention, which are not repeated again herein. For specific steps and figures, refer to Embodiment 2. As shown in FIG. 6, the difference between this embodiment and Embodiment 2 is that this embodiment further includes S409 to S410:

S409: The ARP server receives terminal address information sent by a cloud system management server, where the address information includes the MAC address and the IP address of the terminal

For example, the correspondence between the MAC and the IP of the first terminal is delivered, where the IP address of the first terminal is IP1, and the MAC corresponding to the IP address is MAC1.

S410: The ARP server determines whether the MAC address corresponding to the IP address exists in the locally saved correspondence between an IP address and a MAC address of the terminal. If the MAC address does not exist in the correspondence, the ARP server stores the correspondence between the IP address and the MAC address in the GARP packet in the locally saved correspondence between the IP address and the MAC address of the terminal; if the MAC address exists in the correspondence, the ARP server determines whether the MAC address corresponding to the IP address is consistent with the MAC address in the GARP broadcast packet. If yes, the processing is not performed; and if not, an original MAC address is replaced with the

MAC address in the GAPR broadcast packet.

For example, the ARP server receives terminal address information sent by the management server in S409, the ARP server updates the locally stored correspondence between the MAC address and the IP address according to the information, returns the corresponding information to the management server, and confirms that the MAC information of IP1 is already received.

The locally saved correspondence between the IP address and the MAC address of the terminal may be as shown in Table 2:

TABLE 2

| Sequence No. | IP address | MAC address |
|---|---|---|
| 1 | XXXXXXXX | XXXXXXXX |
| 2 | 10.85.132.31 | 00:0f:e2:2f:e4:6c |
| . . . | . . . | . . . |

Preferably, in order to maintain the accuracy with which the ARP server collects information, the ARP server may send confirmation information to data in a record table at a fixed time in the form of unicast; the MAC and the IP of the host are used as a source MAC and a source IP, and the recorded IP is an ARP request message sent by a destination. If the destination host returns the ARP reply message, effective time is updated, and after the certain time, the ARP reply message is re-detected; and if the ARP replay message is still not received after a few attempts, it may be considered that the host does not exist, so this record is invalid, and deleted from the data base.

The difference between this embodiment and Embodiment 3 mainly lies in different collecting manners of the ARP server information. In this embodiment, a single management system is adopted, MAC and IP address information of all the hosts in the second-layer network are directly set into the ARP server, without the need for the ARP server to acquire the MAC and the IP information of the host by collecting the GARP in the network. This manner is particularly effective in a network of a cloud computing virtualized data center. In the cloud computing virtualized data center, a virtual host is created and managed by a cloud management system, both the MAC address and the IP address thereof are managed and allocated by the cloud management system, therefore, in this case, the correspondence between the IP and the MAC of each virtual host may be set into the ARP server directly by the cloud management system. The load of the ARP server is lightened, and at the same time, the acquired data is more accurate.

### Embodiment 5

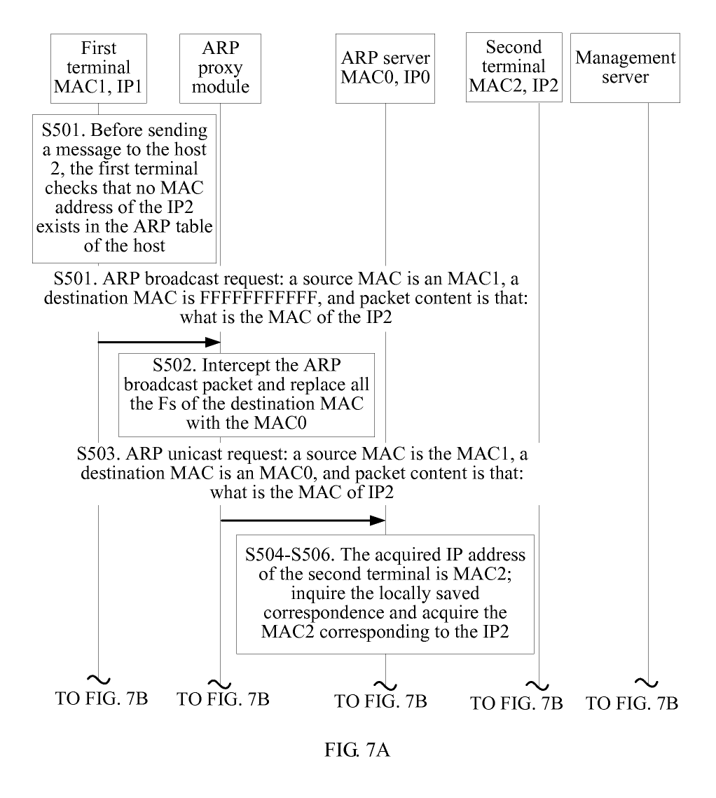

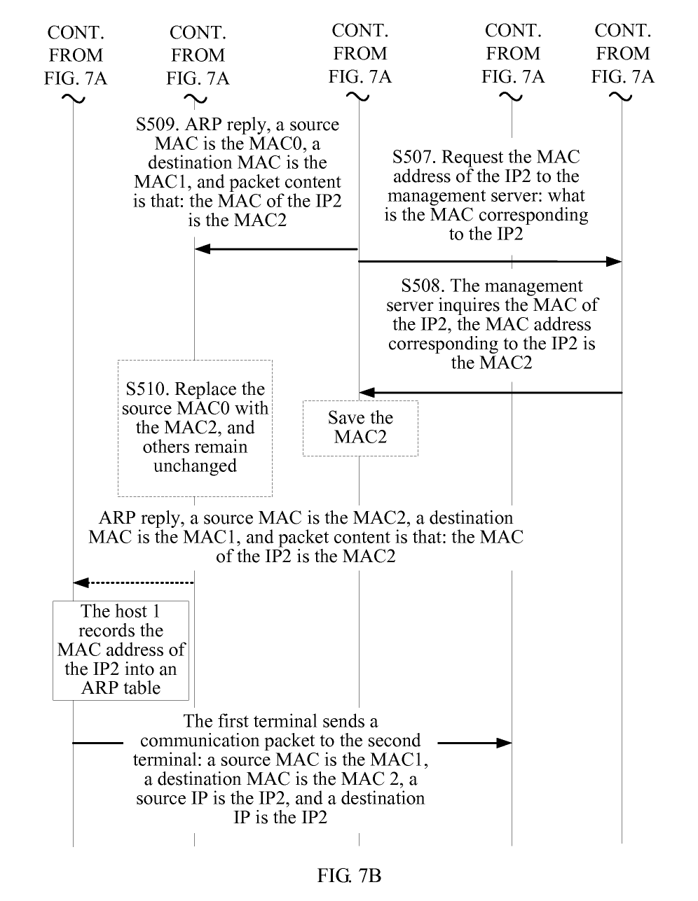

As shown in FIG. 7, an embodiment of the present invention further provides a method for acquiring a MAC address. The method in this embodiment is mainly applied in a network of a cloud computing virtualized data center, and the method relates to a management server, where the management server is configured to create and manage each terminal of a cloud management system, for example, a virtual machine, allocate an IP and a MAC for each terminal, and set corresponding correspondence between the MAC and the IP to the ARP server. The ARP server related in this embodiment is located in a network, and may perform communication with the management server. The method includes steps S501 to S510, where steps S501 to S506 are the same as steps S201 to S206 in Embodiment 2, S509 to S510 are the same as step S207 to S208 in Embodiment 2, which are not repeated again herein. For specific steps and figures, refer to Embodiment 2. The difference between this embodiment and Embodiment 2 is that this embodiment further includes S507 to S508:

S507: When no MAC address corresponding to the IP address of the second terminal exists in the locally saved correspondence between the IP address and the MAC address of the terminal, the ARP server sends the request for acquiring the MAC address corresponding to the IP address of the second terminal to the management server.

For example, when no MAC address corresponding to the IP address of the second terminal exists in the locally saved correspondence between the MAC address and the IP address of the terminal on the ARP server, the ARP server requests the MAC address of an IP2 from the management server, and the packet content is that: “what is the MAC corresponding to the IP2?”

S508: The management server replies to the request, sends the MAC address corresponding to the IP address of the second terminal, namely the MAC2 to the ARP server, and the ARP server stores the correspondence between the IP2 and the MAC2 to the locally saved correspondence.

In this embodiment, when the ARP server receives the request for acquiring the MAC address corresponding to the IP address, when no MAC information corresponding to the IP address exists in the locally saved correspondence, the ARP server actively performs inquiry to the management server, without the need of being delivered by the management server, and the acquiring manner of the MAC information corresponding to the IP address is further improved.

### Embodiment 6

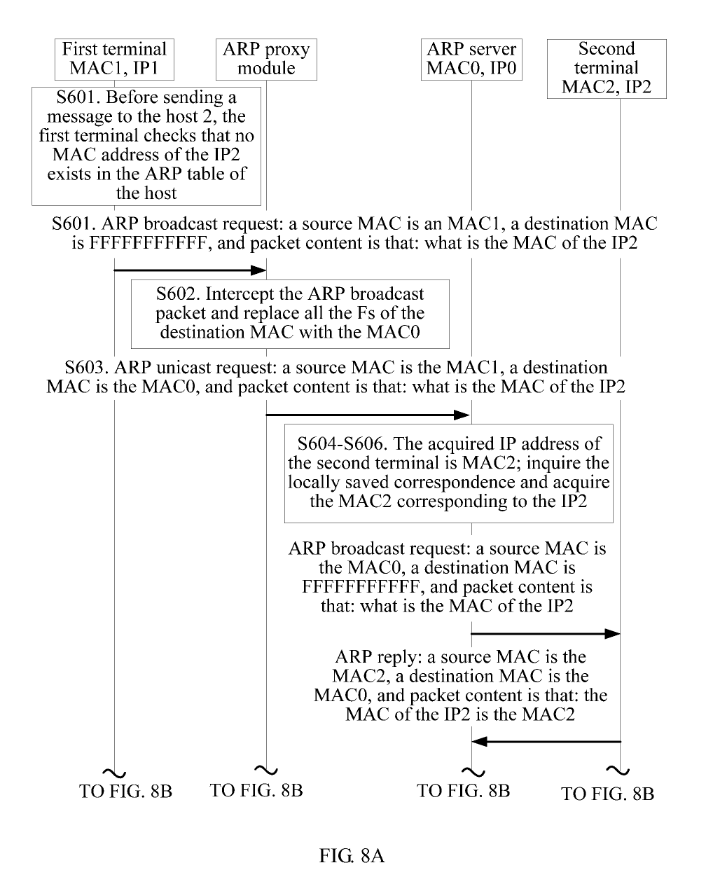

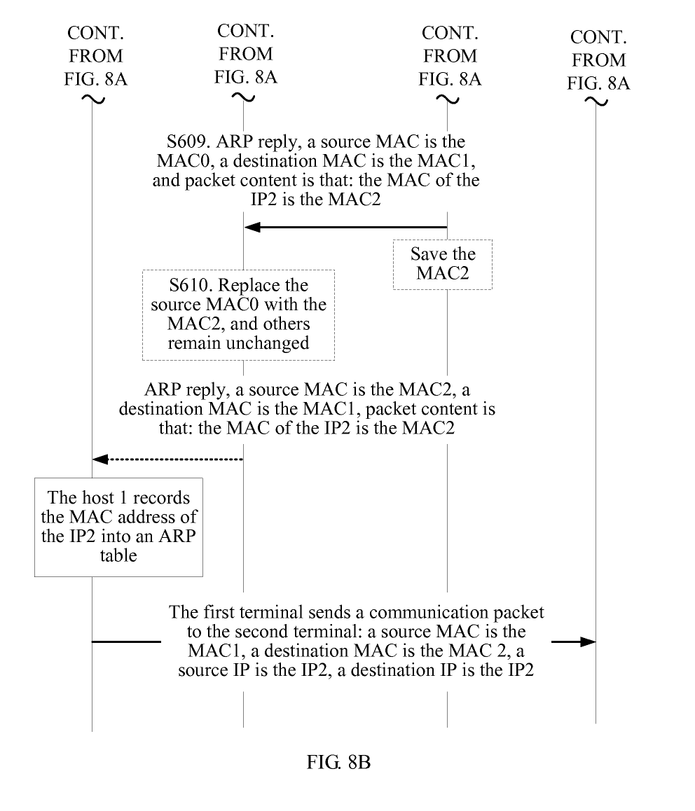

As shown in FIG. 8, an embodiment of the present invention further provides a method for acquiring a MAC address, and the method includes steps S601 to S610. Steps S601 to S606 are the same as step S201 to S206 in Embodiment 2, S609 to S610 are the same as steps S207 to S208 in Embodiment 2, which are not repeated again herein. For specific steps and figures, refer to Embodiment 2. The difference between this embodiment and Embodiment 2 is that this embodiment further includes steps S607 to S608:

S607: After the ARP server receives an ARP requesting packet, initiate broadcast to the overall second-layer network if there is no relevant information in this database.

When there is no MAC address corresponding to an IP address IP2 of a second terminal in the locally saved correspondence on the ARP server, an ARP broadcast request is sent, the requesting source MAC is an MAC0; a destination MAC is: FFFFFFFFFFF; and packet content is that: “what is the MAC of the IP2?”

S608: The second terminal in a second-layer network replies to the broadcast, and sends an ARP reply packet to the ARP server, where the reply packet includes the MAC address of the second terminal.

For example, after receiving the APR broadcast sent in S605, the second terminal sends an ARP reply r. In the ARP reply packet, a source MAC address is an MAC2; a destination MAC address is an MAC0; and packet content is that: the MAC of the IP2 is the MAC2.

In this embodiment, after the ARP server receives the ARP request packet, if the locally saved correspondence between the IP address and the MAC address cannot satisfy the ARP request, the ARP server initiates broadcast to the overall second-layer network, and then returns the ARP reply to an original ARP requester according to the reply packet, thereby assuring the integrity of the overall ARP reply, and preventing ARP request failure caused by not updating the locally saved address information timely.

### Embodiment 7

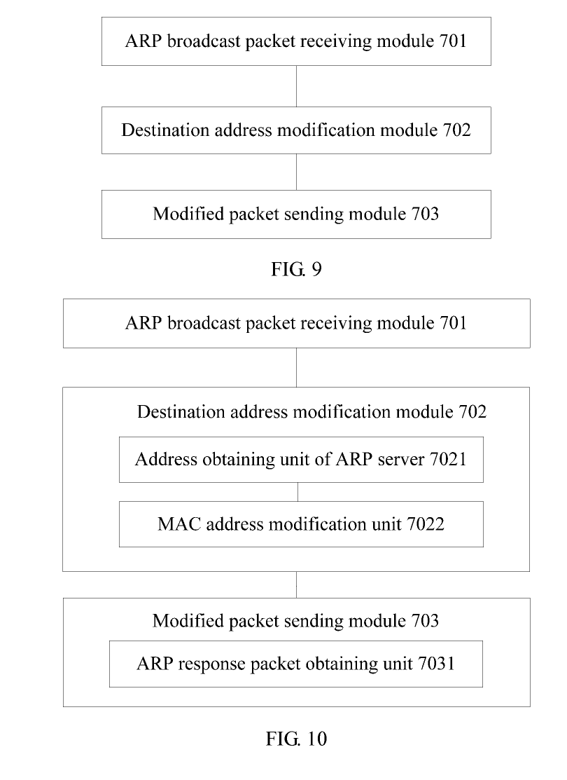

As shown in FIG. 9, an embodiment of the present invention further provides a proxy module, including:

an ARP broadcast packet receiving module 701, configured to receive a first address resolution protocol ARP broadcast packet sent by a first terminal, where the first ARP broadcast packet is used to request to acquire a media access control MAC address of a second terminal; a destination address modification module 702, configured to acquire an address of an ARP server, and modify a destination address of the first ARP broadcast packet into the address of the ARP server; and

a modified packet sending module 703, configured to send the modified first ARP broadcast packet to the ARP server, so that the ARP server acquires the MAC address of the second terminal according to the modified first ARP broadcast packet, and sends an ARP reply packet to the first terminal, where the ARP reply packet includes the MAC address of the second terminal.

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### Embodiment 8

As shown in FIG. 10, an embodiment of the present invention further provides a proxy module, where the proxy module includes an ARP broadcast packet receiving module 701, a destination address modification module 702 and a modified packet sending module 703 in Embodiment 7, where the destination address modification module 702 specifically includes:

an APR server address acquiring unit 7021, configured to acquire a locally saved address of the APR server; and

a MAC address modification unit 7022, configured to, when the locally saved address of the APR server is a MAC address of the ARP server, modify a destination MAC address of the first ARP broadcast packet into the MAC address of the ARP server; and when the locally saved address of the APR server is an IP address of the ARP server, acquire the MAC address of the ARP server, and modify the destination MAC address of the first ARP broadcast packet into the acquired MAC address of the ARP server.

The modified packet sending module 703 specifically includes:

an ARP reply packet acquiring unit 7031, configured to acquire a ARP reply packet, replace a source MAC address in the ARP reply packet with the MAC address of the second terminal, replace a source IP address in the ARP reply packet with an IP address of the second terminal, and send the modified ARP reply packet to the first terminal

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### Embodiment 9

As shown in FIG. 11, an embodiment of the present invention further provides an ARP server, including:

an IP address acquiring module 801 of a second terminal, configured to acquire an IP address of the second terminal in a modified first ARP broadcast packet; and

a MAC address acquiring module 802 of the second terminal, configured to inquire correspondence between the IP address of the terminal and a MAC address of the terminal, and acquire the MAC address corresponding to the IP address of the second terminal

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### Embodiment 10

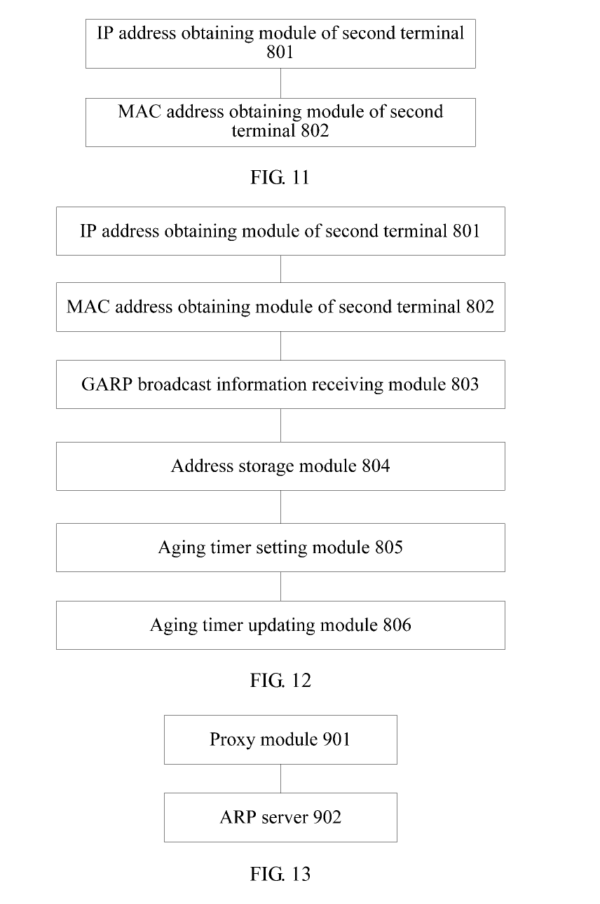

As shown in FIG. 12, an embodiment of the present invention further provides an ARP server, where the ARP server includes an IP address acquiring module 801 of a second terminal and the MAC address acquiring module 802 of the second terminal in Embodiment 9, where the ARP server further includes:

a GARP broadcast information receiving module 803, configured to receive GARP broadcast information sent by all terminals in the same network as the ARP server;

an address storing module 804, configured to acquire and save an IP address of the terminal and a MAC address of the terminal in the GARP broadcast information;

an aging timer setting module 805, configured to set an aging timer for the saved IP address and the saved MAC address of the terminal; and

an aging timer updating module 806, configured to update the aging timer according to the received GARP broadcast information sent by all the terminals in the same network as the ARP server.

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

### Embodiment 11

As shown in FIG. 13, an embodiment of the present invention further provides a system for acquiring a media access control address, where the system includes a proxy module 901 and an ARP server 902, where:

the proxy module 901 is configured to receive a first address resolution protocol ARP broadcast packet sent by a first terminal, where the first ARP broadcast packet is used to request to acquire a media access control MAC address of a second terminal; acquire an address of an ARP server, modify a destination address of the first ARP broadcast packet into the address of the ARP server; and send the modified first ARP broadcast packet to the ARP server;

optionally, the proxy module 901 is further configured to acquire an ARP reply packet, replace a source MAC address in the ARP reply packet with the MAC address of the second terminal, replace a source IP address in the ARP reply packet with an IP address of the second terminal, and send the modified ARP reply packet to the first terminal; and

the ARP server 902 is configured to receive the modified first ARP broadcast packet sent by the proxy module; acquire the MAC address of the second terminal according to the modified first ARP broadcast packet, and send the ARP reply packet to the first terminal, where the ARP reply packet includes the MAC address of the second terminal.

In the embodiment of the present invention, the address of the ARP server is acquired, and the destination address of the first ARP broadcast packet is modified into the address of the ARP server; the ARP broadcast packet becomes a unicast packet sent to only the ARP server, the network bandwidth occupied by the ARP broadcast is reduced. Besides, because the modified ARP broadcast packet is sent to only the ARP server and the ARP reply packet including the MAC address of the second terminal is sent by the ARP server, and other receiving ends in the network cannot receive the modified ARP broadcast packet, occupancy of CPU resources of other receiving ends in the network is prevented, and a resource utilization rate of the system and a communication efficiency of each terminal are improved.

All or a part of the content in the technical solutions provided by the preceding embodiments may be implemented by a software program. The software program may be stored in a readable storage medium, such as a hard disk, an optical disk, a floppy disk or a Flash memory of the computer.

The foregoing describes only exemplary embodiments of the present invention and is not intended to limit the present invention. Any modification, equivalent replacement, or improvement made without departing the spirit and principle of the present invention shall fall within the protection scope of the present invention.

1. A method executed by a proxy device in an Ethernet network to assist a first terminal in the Ethernet network to obtain a Medium/Media Access Control (MAC) address of a second terminal in the Ethernet network, comprising:
receiving a first address resolution protocol (ARP) broadcast packet sent by the first terminal for acquiring the MAC address of the second terminal;
acquiring a MAC address of an ARP server on the Ethernet network;
replacing a destination MAC address in the first ARP broadcast packet with the MAC address of the ARP server to generate a modified packet; and
sending the modified packet to the ARP server to request the ARP server to provide the MAC address of the second terminal to the first terminal.

2. The method according to claim 1, wherein the step of acquiring the MAC address of the ARP server includes retrieving the MAC address of the ARP server from a local memory of the proxy device.

3. A proxy device for assisting acquisition of Medium/Media Access Control (MAC) address in an Ethernet network, comprising:
an address resolution protocol (ARP) broadcast packet receiving module, configured to receive a first ARP broadcast packet sent by a first terminal on the Ethernet network for acquiring a MAC address of a second terminal;
a destination address modification module, configured to acquire a MAC address of an ARP server on the Ethernet network, and replace a destination MAC address in the first ARP broadcast packet with the MAC address of the ARP server to generate a modified packet; and
a packet sending module, configured to send the modified packet to the ARP server to request the ARP server to provide the MAC address of the second terminal to the first terminal

4. The proxy device according to claim 3, wherein the proxy device includes a memory for saving the MAC address of the ARP server.

5. A method for assisting a first terminal in an Ethernet network to obtain a Medium/Media Access Control (MAC) address of a second terminal in the Ethernet network, comprising:
receiving, by a proxy device, a first address resolution protocol (ARP) broadcast packet sent by the first terminal for acquiring the MAC address of the second terminal, the first ARP broadcast packet including a sender MAC address, a sender IP address, an IP address of the second terminal, and a destination MAC address;
acquiring, by the proxy device, a MAC address of an ARP server;
replacing, by the proxy device, the destination MAC address in the first ARP broadcast packet with the MAC address of the ARP server to generate a modified packet;
sending, by the proxy device, the modified packet to the ARP server;
receiving, by the ARP server, the modified packet;
obtaining, by the ARP server, the IP address of the second terminal from the modified packet;
acquiring, by the ARP server, the MAC address of the second terminal according to the IP address of the second terminal; and
sending, by the ARP server, an ARP reply packet including the MAC address of the second terminal to the first terminal.

6. The method according to claim 5, wherein the step of acquiring the MAC address of the second terminal comprises:
searching, by the ARP server according to the IP address of the second terminal, a mapping table indicating a mapping between MAC addresses and IP addresses for one or more terminals.

7. The method according to claim 5, wherein the step of acquiring the MAC address of the ARP server includes retrieving the MAC address of the ARP server from a local memory of the proxy device.

8. The method according to claim 5, further comprising:
receiving, by the ARP server, a Gratuitous ARP (GARP) broadcast packet from the second terminal;
obtaining, by the ARP server, an IP address of the second terminal from the GARP broadcast packet;
determining, by the ARP server, that the IP address of the second terminal has not been stored in the mapping table; and
storing, in the mapping table by the ARP server, the IP address of the second terminal and a MAC address of the second terminal obtained from the GARP broadcast packet.

9. The method according to claim 5, further comprising:
receiving, by the ARP server, a Gratuitous ARP (GARP) broadcast packet from the second terminal;
obtaining, by the ARP server, an IP address of the second terminal and a MAC address of the second terminal from the GARP broadcast packet;
determining, by the ARP server, that a stored MAC address of the second terminal stored in the mapping table is different from the MAC address of the second terminal obtained from the GARP broadcast packet;
replacing, by the ARP server, the stored MAC address of the second terminal stored in the mapping table with the MAC address of the second terminal obtained from the GARP broadcast packet.

10. The method for acquiring MAC address according to claim 5, further comprising:
receiving, by the ARP server, a terminal address message including an IP address of the second terminal and a MAC address of the second terminal;
determining, by the ARP server, that a stored MAC address of the second terminal stored in the mapping table is different from the MAC address of the second terminal in the terminal address message; and
replacing, by the ARP server, the stored MAC address of the second terminal in the mapping table with the MAC address of the second terminal in the terminal address message.

11. The method according to claim 6, after searching the mapping table by the ARP server, the method further comprising:
determining, by the ARP server, that there is no MAC address in the mapping table corresponding to the IP address of the second terminal based upon the searching;
obtaining a MAC address of the second terminal from a management server; and
saving, by the ARP server, the MAC address of the second terminal and the IP address of the second terminal in the mapping table.

12. The method for acquiring MAC address according to claim 6, after searching the mapping table by the ARP server, the method further comprising:
determining, by the ARP server, that there is no MAC address corresponding to the IP address of the second terminal based upon the searching;
initiating, by the ARP server, a broadcast to the Ethernet network in order to acquire a MAC address of the second terminal;
receiving, by the ARP server, the MAC address of the second terminal from the second terminal; and
saving, by the ARP server, the MAC address of the second terminal and the IP address of the second terminal in the mapping table.

13. A system for assisting a first terminal in an Ethernet network to obtain a Medium/Media Access Control (MAC) address of a second terminal in the Ethernet network, comprising: a proxy device and an Address Resolution Protocol (ARP) server;
the proxy device being configured to:
receive, a first ARP broadcast packet sent by the first terminal for acquiring the MAC address of the second terminal, the first ARP broadcast packet including a sender MAC address, a sender IP address, an IP address of the second terminal, and a destination MAC address;
acquire a MAC address of the ARP server; replace the destination MAC address of the first ARP broadcast packet with the MAC address of the ARP server to generate a modified packet; and
send the modified packet to the ARP server; and
the ARP server being configured to:
receive the modified packet;
obtain the IP address of the second terminal from the modified packet;
acquire the MAC address of the second terminal according to the IP address of the second terminal; and
send an ARP reply packet including the MAC address of the second terminal to the first terminal.

14. The system according to claim 13, wherein the APR server acquire the MAC address of the second terminal by searching according to the IP address of the second terminal, a mapping table indicating a mapping between MAC addresses and IP addresses for one or more terminals.

15. The system according to claim 13, wherein the proxy device includes a memory for saving the MAC address of the ARP server.

16. The system according to claim 13, wherein the ARP server is further configured to:
receive a Gratuitous ARP (GARP) broadcast packet from the second terminal;
obtain an IP address of the second terminal from the GARP broadcast packet;
determine that the IP address of the second terminal has not been stored in the mapping table; and
store, in the mapping table, the IP address of the second terminal and a MAC address of the second terminal obtained from the GARP broadcast packet.

17. The system according to claim 13, wherein the ARP server is further configured to:
receive a Gratuitous ARP (GARP) broadcast packet from the second terminal;
obtain an IP address of the second terminal and a MAC address of the second terminal from the GARP broadcast packet;
determine that the MAC address of the second terminal stored in the mapping table is different from the MAC address of the second terminal obtained from the GARP broadcast packet; and
replace the MAC address of the second terminal stored in the mapping table with the MAC address of the second terminal obtained from the GARP broadcast packet.

18. The system according to claim 13, wherein the ARP server is further configured to:
receive a terminal address message including an IP address of the second terminal and a MAC address of the second terminal;
determine that the IP address of the second terminal has not been stored in the mapping table; and
store the IP address of the second terminal and the MAC address of the second terminal obtained from the GARP broadcast packet.

19. The system according to claim 13, wherein the ARP server is further configured to:
receive a terminal address message including an IP address of the second terminal and a MAC address of the second terminal;
determine that a stored MAC address of the second terminal in the mapping table is different from the MAC address of the second terminal in the terminal address message;
replace the stored MAC address of the second terminal in the mapping table with the MAC address of the second terminal in the terminal address message.
